(19) United States
(12) Patent Application Publication
(10) Pub. No.: US 2010/0211965 A1
(43) Pub. Date: Aug. 19, 2010

(54) CLAMP STRUCTURE IN DISK PLAYING DEVICE

(75) Inventor: Kunio KIDO, Tokyo (JP)

Correspondence Address: CANTOR COLBURN, LLP, 20 Church Street, 22nd Floor, Hartford, CT, 06103, US

(73) Assignee: NIDEC PIGEON CORPORATION, Tokyo (JP)

(21) Appl. No.: 12/708,608

(22) Filed: Feb. 19, 2010

(30) Foreign Application Priority Data
Feb. 19, 2009 (JP) 2009-037094

(51) Int. Cl. G11B 17/03

(52) U.S. Cl. 720/706; G9B/17.009

(57) ABSTRACT

A clamp structure in a disk playing device is structured so that a clamper and a turntable are magnetically coupled to each other to sandwich a disk and that one of the clamper and the turntable is separated from the other to release magnetic coupling and detach the disk. The clamp structure may include a disk stopper for supporting the disk when, for example, the turntable is to be separated from the clamper to prevent the disk and the clamper from following and moving together with the turntable. The disk stopper may be disposed so as to face a non-recording area except a recording area of the disk and the disk stopper may be structured by utilizing a part of a chassis or a feeding roller for feeding the disk.

### CROSS REFERENCE TO RELATED APPLICATION

The present invention claims priority under 35 U.S.C. §119 to Japanese Application No. 2009-37094 filed Feb. 19, 2009, the entire contents of which are incorporated herein by reference.

### FIELD OF THE INVENTION

An embodiment of the present invention may relate to a clamp structure in a disk playing device. More specifically, an embodiment of the present invention may relate to a clamp structure in a disk playing device in which a clamper and a turntable are magnetically coupled to each other to clamp a disk.

### BACKGROUND OF THE INVENTION

A disk playing device in which a clamper and a turntable are magnetically coupled to each other to clamp and play a disk has been disclosed, for example, in Japanese Patent Laid-Open No. 2005-149561. In the disk playing device, as shown in FIGS. 26 and 27, a clamper 103 is rotatably supported by a clamper plate 102 which is arranged between both side wall parts 101a of a housing 101. The clamper 103 is provided with a magnet 104 and, when a turntable 105 is moved upward to bring close to the clamper 103, they are magnetically coupled to each other. In this case, the turntable 105 is moved upward from a lower side of a tray 106 and a disk 107 is lifted up from the tray 106. In this manner, the clamper 103 and the turntable 105 are magnetically coupled to each other in a state that the disk 107 is clamped between them and, in this state, the turntable 105 is rotated to play the disk 107.

When a playing operation of the disk 107 has ended and rotation of the turntable 105 has been stopped, the turntable 105 is moved down and the disk 107 is to be returned on the tray 106. In this case, the clamper 103 magnetically coupled to the turntable 105 also tends to move downward together with the turntable 105. However, since the clamper 103 is supported by the clamper plate 102, the clamper 103 cannot be moved down together with the turntable 105 and thus the clamper 103 is separated from the turntable 105 and the disk 107 and the turntable 105 are moved down while the clamper 103 is left. The clamper plate 102 is a strength member which is made of a steel plate and provided with a large rigidity, and which is formed with front and rear upward side edge reinforcing parts 108, a downward ring-shaped reinforcing part 109, and right and left upward protruded and elongated reinforcing parts 110 and, in this manner, a strength which is required to separate the clamper 103 from the turntable 105 is secured.

However, in the disk playing device described above, since the clamper 103 is supported by the clamper plate 102, it is difficult to reduce the size of the device and the number of part items is increased and thus its manufacturing cost is increased. Further, the clamper plate 102 is extended and arranged between the side wall parts 101a of the housing 101 for supporting the clamper 103 at its center position and thus the clamper plate 102 is required to secure a sufficient strength. Therefore, expensive material, extra forming steps or the like are required to structure the clamper plate 102 and thus a manufacturing cost of the clamper plate 102 itself is also increased.

### SUMMARY OF THE INVENTION

In view of the problems described above, at least an embodiment of the present invention may advantageously provide a clamp structure in a disk playing device which is capable of reducing its size and manufacturing cost.

According to at least an embodiment of the present invention, there may be provided a clamp structure in a disk playing device in which a clamper and a turntable are magnetically coupled to each other to sandwich a disk between them, and in which one member of the clamper and the turntable is separated from the other member of the clamper and the turntable to release magnetic coupling for detaching the disk. The clamp structure is provided with a disk stopper for supporting the disk when the one member is to be separated from the other member to prevent the disk and the other member from following and moving together with the one member.

In a state that one member is magnetically coupled to the other member to clamp a disk, when one member is moved, the other member and the disk are also moved together. However, after the disk is abutted with the disk stopper, the disk and the other member cannot be moved together with the one member and thus the one member is separated from the disk and the other member to release the clamp of the disk.

In accordance with an embodiment of the present invention, the disk stopper is disposed so as to face a non-recording area except a recording area of the disk and the disk stopper is supported by a chassis. In this case, a reaction force from the disk which is applied to the disk stopper at the time of releasing of the magnetic coupling is received by the chassis whose strength is originally higher. The disk stopper is abutted with the non-recording area except the recording area of the disk and thus the recording area of the disk is not damaged. Further, an additional structural member is not required for supporting the disk stopper and thus its manufacturing cost is reduced and the weight and size of the device can be restrained. Further, since the disk stopper is not abutted with the recording area of the disk, the recording area of the disk is prevented from being damaged by the disk stopper. Specifically, the disk stopper is provided on the chassis so as to be capable of sliding in a feeding direction of the disk, and an up-and-down mechanism for moving the disk stopper up and down through sliding of the disk stopper is provided between the disk stopper and the chassis.

In accordance with an embodiment of the present invention, the disk stopper is structured of a part of a chassis which faces a non-recording area except a recording area of the disk. Also in this case, a reaction force from the disk at the time of releasing of the magnetic coupling is received by the chassis whose strength is originally higher. The disk stopper is abutted with the non-recording area except the recording area of the disk and thus the recording area of the disk is not damaged. Further, in a case that the disk stopper is formed by utilizing a part of the chassis, a reaction force from the disk at the time of releasing of the magnetic coupling is received by the chassis whose strength is originally higher. Therefore, an additional structural member is not required for supporting the disk stopper and thus its manufacturing cost is reduced and the weight and size of the device can be restrained. Further, since the disk stopper is not abutted with the recording area of the disk, the recording area of the disk is prevented from being damaged by the disk stopper. Specifically, since a hole is formed in the chassis for passing the turntable, the disk stopper may be formed in the chassis by utilizing a peripheral portion of the hole. Further, the disk stopper may be formed in a portion of the chassis which faces a tip end portion of the disk.

In accordance with an embodiment of the present invention, the disk stopper is structured of a feeding roller for feeding the disk into a disk play operation space. In this case, a reaction force at the time of releasing of the magnetic coupling is received by the feeding roller whose strength is originally higher. Since the feeding roller is used to abut and feed a disk and thus it does not damage the recording area of the disk. Further, when the disk stopper is formed by utilizing the feeding roller, a reaction force from the disk at the time of releasing of the magnetic coupling is received by the feeding roller whose strength is originally higher. Therefore, an additional structural member is not required for supporting the disk stopper and thus its manufacturing cost is reduced and the weight and size of the device can be restrained. Further, since the disk stopper is structured of the feeding roller, the recording area of the disk is prevented from being damaged by the disk stopper. Specifically, the feeding roller is attached to the chassis so that the feeding roller is urged for abutting with the disk by a spring, and an urging force of the spring which is applied to the feeding roller may be set so that the feeding roller abutting with the disk is prevented from following the turntable when the turntable is to be separated from the clamper. Further, it may be structured so that the feeding roller is rotatably supported by a swing arm which is swingably attached to the chassis and, when the disk is to be ejected, the feeding roller is swung and abutted with the disk through the swing arm and the turntable is separated from the disk and the clamper through the feeding roller.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a side view showing a clamp structure in a disk playing device in accordance with a first embodiment of the present invention, which is in a waiting state before a tray begins to move to a play position.

FIG. 2 is a side view showing a state subsequent to the state in FIG. 1 where the tray is moving toward the play position.

FIG. 3 is a side view showing a state subsequent to the state in FIG. 2.

FIG. 4 is a side view showing a state subsequent to the state in FIG. 3 where the tray has reached to the play position.

FIG. 5 is a side view showing a state subsequent to the state in FIG. 4 where a disk is played.

FIG. 6 is a side view showing a state subsequent to the state in FIG. 5 where the turntable is moved downward and the disk is abutted with a disk stopper.

FIG. 7 is a side view showing a state subsequent to the state in FIG. 6 where magnetic coupling of the turntable to the clamper 2 has been released.

FIG. 8 is a side view showing a state subsequent to the state in FIG. 7 where the disk whose play operation has ended is placed on the tray.

FIG. 9 is a side view showing a state subsequent to the state in FIG. 8 where the disk whose play operation has ended is ejected.

FIGS. 10(A), 10(B) and 10(C) are side views showing an up-and-down mechanism. FIG. 10(A) is a cross-sectional side view showing a state at an initial position, FIG. 10(B) is a cross-sectional side view showing a state where a disk stopper is being moved upward, and FIG. 10(C) is a cross-sectional side view showing a state where the disk stopper has been moved upward.

FIGS. 11(A) and 11(B) are plan views showing states where the disk stopper is moved by the tray. FIG. 11(A) is a plan view showing a state before the disk stopper is moved by the tray, and FIG. 11(B) is a plan view showing a state where the disk stopper has been moved by the tray.

FIG. 12 is a perspective view showing the disk stopper, the tray and a chassis.

FIG. 13 is an explanatory cross-sectional view showing a recording area and a non-recording area except the recording area of the disk.

FIG. 14 is a cross-sectional view showing a state where the disk is clamped by the turntable and the clamper.

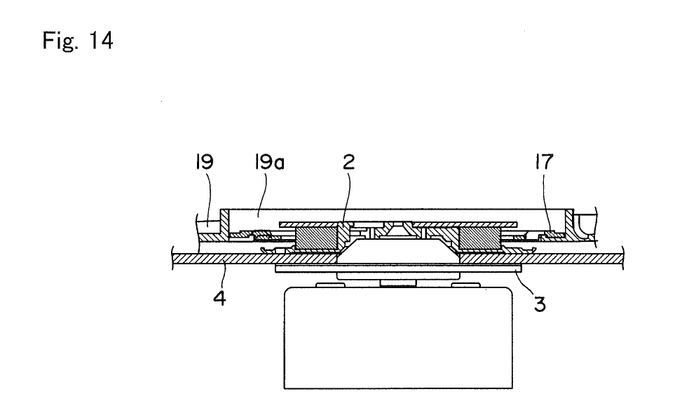

FIG. 15 is a cross-sectional side view showing a clamp structure in a disk playing device in accordance with a second embodiment of the present invention which is a state where a disk is carried into a disk play operation space.

FIG. 16 is a cross-sectional side view showing a state subsequent to the state in FIG. 15 where the disk is played.

FIG. 17 is a cross-sectional side view showing a state subsequent to the state in FIG. 16 where the turntable is moved downward and the disk is abutted with a disk stopper.

FIG. 18 is an explanatory cross-sectional view showing an operation of the clamp structure in the disk playing device shown in FIG. 15.

FIG. 19 is a side view showing a clamp structure in a disk playing device in accordance with a third embodiment of the present invention. FIG. 19 is a cross-sectional side view showing a state where a turntable is moved downward and a disk is abutted with a disk stopper and magnetic coupling is released.

FIG. 20 is a cross-sectional side view showing a clamp structure in a disk playing device in accordance with a fourth embodiment of the present invention in which a turntable is moved downward and a disk is abutted with disk stoppers.

FIGS. 21(A) and 21(B) are cross-sectional views showing a support structure for a clamper in the disk playing device. FIG. 21(A) is a cross-sectional view showing a state before a disk is clamped and FIG. 21(B) is a cross-sectional view after the disk is clamped.

FIG. 22(A) is a plan view showing a hole of a frame, FIG. 22(B) is a plan view showing a clamper holder, and FIG. 22(C) is a plan view showing a positional relationship when the clamper holder is disposed in the hole.

FIGS. 23(A), 23(B) and 23(C) are views showing a guide mechanism. FIG. 23(A) is a view showing a positional relationship when a disk is carried, FIG. 23(B) is a view showing a positional relationship when the disk is clamped, and FIG. 23(C) is a view showing a positional relationship when the disk is played.

FIGS. 24(A), 24(B) and 24(C) are views for explaining an effect when inclination of a clamper is restrained. FIG. 24(A) is a schematic structure view showing a state where a disk is clamped by a turntable and a clamper, FIG. 24(B) is a schematic structure view showing a distance between the turntable and the clamper, and FIG. 24(C) is a schematic structure view showing representative points for calculation.

FIGS. 25(A), 25(B) and 25(C) are views showing comparison examples in a case that a clamper is inclined. FIG. 25(A) is a schematic structure view showing a state where a disk is clamped by a turntable and a clamper, FIG. 25(B) is a schematic structure view showing a distance between the turntable and the clamper, and FIG. 25(C) is a schematic structure view showing representative points for calculation.

FIG. 26 is a perspective view showing a clamp structure in a conventional disk playing device.

FIG. 27 is a cross-sectional view showing the clamp structure in the conventional disk playing device.

FIG. 28 is a perspective view showing a disk playing device in which a conventional support structure for a clamp is adopted.

FIG. 29 is a perspective view showing the conventional support structure for a clamp.

### DETAILED DESCRIPTION OF THE PREFERRED EMBODIMENTS

Structures in accordance with embodiments of the present invention will be described in detail below with reference to the accompanying drawings.

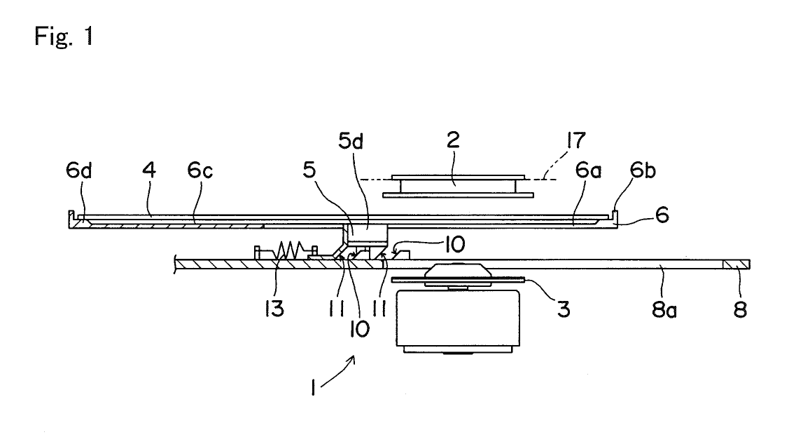

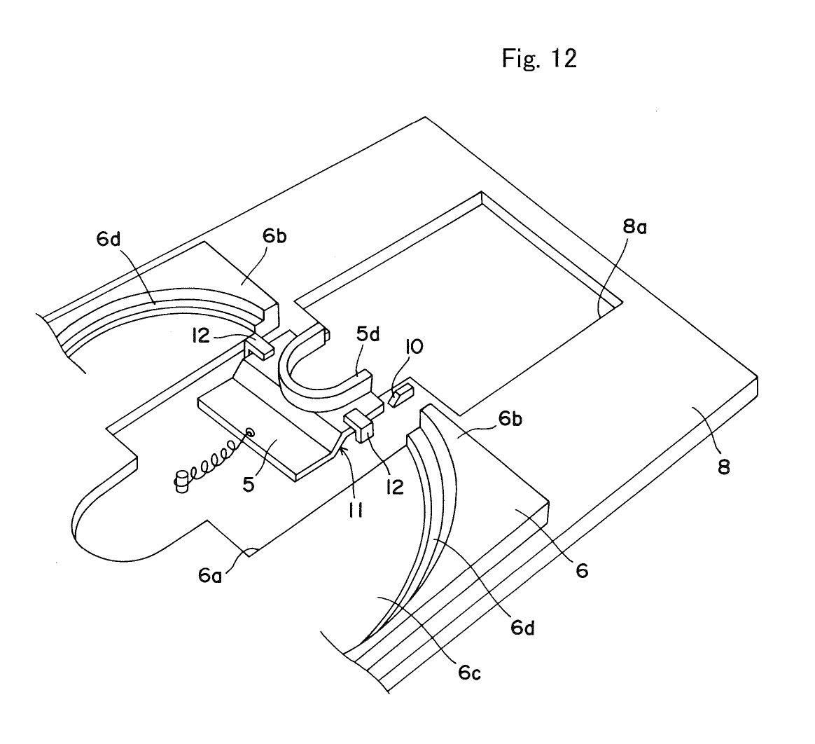

A clamp structure in a disk playing device in accordance with a first embodiment of the present invention is shown in FIGS. 1 through 12. A clamp structure 1 in a disk playing device (hereinafter, simply referred to as a clamp structure) is a mechanism in which a clamper 2 and a turntable 3 are magnetically coupled to each other to clamp a disk 4 between them and in which one member of the clamper 2 and the turntable 3 is separated from the other member to release the magnetic coupling for ejecting the disk 4. The clamp structure 1 is provided with a disk stopper 5 for supporting the disk 4 when the one member is separated from the other member to prevent the disk 4 and the other member from following and moving together with the one member.

In the embodiments of the present invention, the turntable 3 (one member) is structured to be movable and separated from the clamper 2 (the other member). However, the present invention is not limited to this structure and it may be structured that the clamper 2 (one member) is structured to be movable and separated from the turntable 3 (the other member). Further, in the embodiments of the present invention, the present invention is applied to a horizontal type disk playing device, in other words, a disk playing device in which a disk 4 is handled in a horizontal state (laid state). However, the present invention is not limited to a horizontal type disk playing device and may be applied, for example, to a vertical type disk playing device in which a disk 4 is handled in a vertical state (standing state). In the embodiments of the present invention, an up and down movement in a horizontal disk playing device corresponds to a horizontal movement in a vertical type disk playing device. In addition, in the embodiments of the present invention, the present invention is applied to a disk playing device where a disk 4 is placed and carried with a tray 6. However, the present invention is not limited to the disk playing device with the use of a tray 6. For example, the present invention may be applied to a disk playing device or the like in which a feeding roller 7 is directly abutted with a disk 4 to carry it without using the tray 6.

The disk stopper 5 in the first embodiment is a member which is different from a chassis 8 and the disk stopper 5 is supported by the chassis 8. However, it is not necessary to form the disk stopper 5 as a different member from the chassis 8 and the disk stopper 5 may be integrally formed with the chassis 8. Further, a part of the chassis 8 or a feeding roller 7 may be used as the disk stopper 5. The disk stopper 5 in the first embodiment is provided on the chassis 8 so as to be capable of sliding in a front and rear direction (feeding direction of the disk 4).

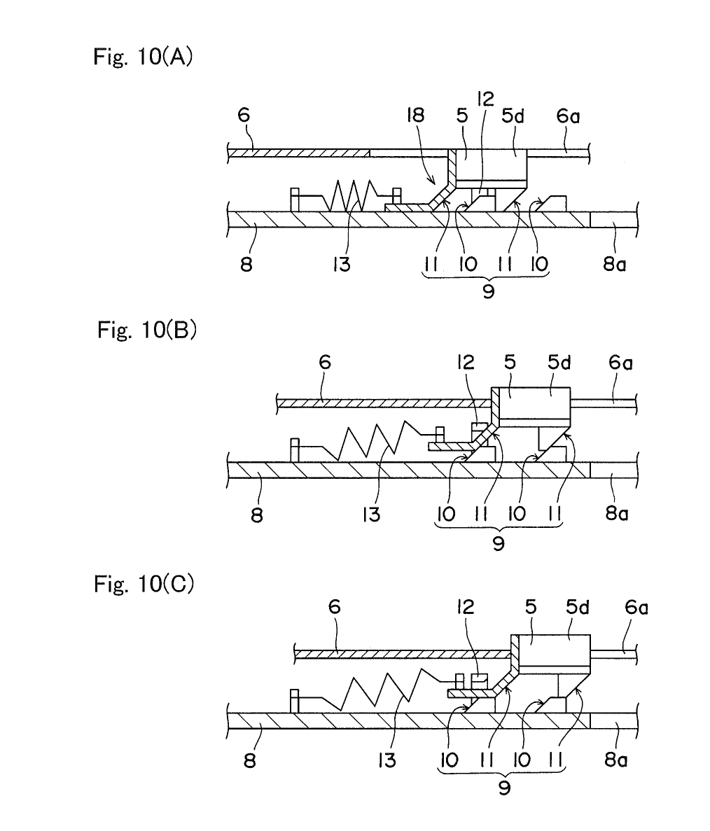

An up-and-down mechanism 9 is provided between the disk stopper 5 and the chassis 8 for moving the disk stopper 5 up and down by a sliding operation of the disk stopper 5. The up-and-down mechanism 9 is enlargedly shown in FIGS. 10(A), 10(B) and 10(C). The up-and-down mechanism 9 in the first embodiment is structured of chassis side inclined faces 10, which are provided on an upper face of the chassis 8, and stopper side inclined faces 11 which are provided on bottom faces of the disk stopper 5. The chassis side inclined face 10 and the stopper side inclined face 11 are faced each other and the stopper side inclined face 11 is moved up and down while the stopper side inclined face 11 slides on the chassis side inclined face 10 through a sliding operation of the disk stopper 5.

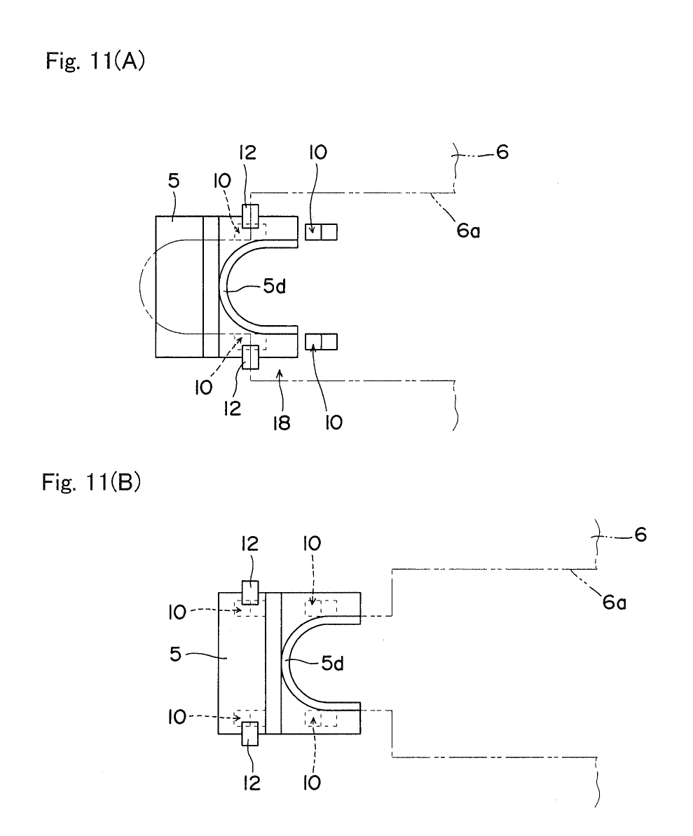

In the first embodiment, the chassis side inclined face 10 and the stopper side inclined face 11 are respectively provided on a front side and a rear side. The stopper side inclined face 11 on the front side (inlet side in the feeding direction of the disk 4; left side in FIG. 1) is formed by means of that the disk stopper 5 itself is partially inclined, and the stopper side inclined faces 11 on the rear side (back side in the feeding direction of the disk 4; right side in FIG. 1) are formed by means of that a pair of right and left projecting parts is formed on the bottom face of the disk stopper 5 (FIGS. 11(A) and 11(B)). Further, the chassis side inclined faces 10 on the front side and the rear side are respectively formed so that a pair of right and left projecting parts are formed on the chassis 8. In this embodiment, the chassis 8 is provided with a hole 8a for allowing the turntable 3 to pass and an optical pickup not shown to face the disk 4. The chassis side inclined face 10 on the rear side is formed on the right and left sides across the hole 8a. However, structure of the chassis side inclined face 10 and the stopper side inclined face 11 is not limited to this embodiment. The chassis 8 is provided with a guide part 12 for guiding the disk stopper 5 and for preventing the disk stopper 5 from detaching from the chassis 8.

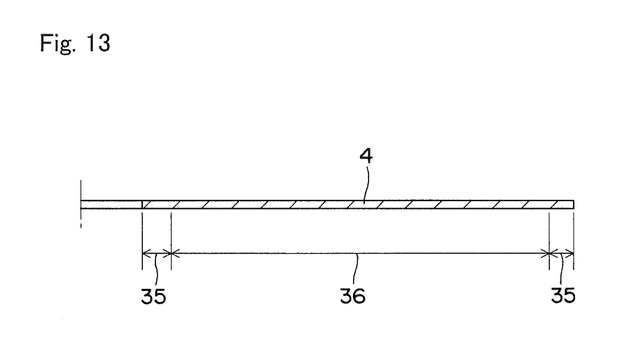

An upper face of the disk stopper 5 in the first embodiment is formed with a support part 5d which is capable of supporting a non-recording area 35 (FIG. 13) except the recording area 36 of the under face of the disk 4. The support part 5d in this embodiment is capable of supporting an inner non-recording area 35 (left side in FIG. 13) with respect to the recording area 36 of the disk 4. However, the non-recording area 35 except the recording area 36 which is to be supported by the support part 5d is not limited to the inner non-recording area 35 with respect to the recording area 36 but may be an outer non-recording area 35 (right side in FIG. 13) with respect to the recording area 36. An upper face of the support part 5d is protruded to a higher position than the tray 6. Further, a return spring 13 is provided between the disk stopper 5 and the chassis 8. The return spring 13 always urges the disk stopper 5 toward an initial position 18 shown in FIG. 10(A).

The support part 5d in the first embodiment also faces the clamper 2, in other words, the support part 5d is overlapped with the clamper 2 in a radial direction, when magnetic coupling of the turntable 3 to the clamper 2 is to be released. Therefore, for example, in a state that a disk 4 is not loaded, when the turntable 3 and the clamper 2 are directly magnetically coupled to each other and the magnetic coupling is to be released, the clamper 2 is directly supported by the support part 5d of the disk stopper 5. However, the support part 5d is not always required to overlap with the clamper 2 in the radial direction. For example, when the turntable 3 and the clamper 2 are structured so as not to be directly magnetically coupled to each other or the like in a state that a disk 4 is not loaded, the support part 5d may not be required to overlap with the clamper 2 in the radial direction.

The clamper 2 is disposed on an upper side of the disk 4 and is rotatably supported by a clamper holder 17 so as to be movable in an up-and-down direction. The clamper holder 17 is, for example, a ring shaped plate-like member which is made of resin and is attached movably in an up-and-down direction within a hole 19a formed in a frame 19. The clamper holder 17 is moved in the up-and-down direction with respect to the frame 19 by an operation means not shown. For example, a support structure 24 for the clamper 2 which will be described below may be used as a mechanism for moving the clamper holder 17 in the up-and-down direction.

The turntable 3 is disposed under the chassis 8 and is attached to a sub-chassis together with an optical pickup. When the sub-chassis is moved upward by an up-and-down drive means not shown, the turntable 3 is protruded to an upper side of the tray 6 through the hole 8a of the chassis 8 and a cut-out part 6a of the tray 6 to lift the disk 4 so as to be capable of magnetically coupling to the clamper 2. Further, in a state that the turntable 3 is magnetically coupled to the clamper 2, the optical pickup is oppositely disposed to the recording area 36 of the disk 4 through the hole 8a of the chassis 8 and the cut-out part 6a of the tray 6.

A disk 4 is placed on a circular recessed part 6c which is formed in the tray 6. An outer circumferential edge of the circular recessed part 6c is formed with a projecting part 6d for supporting an outer circumferential edge of the disk 4. Therefore, the disk 4 is placed in a floated state with respect to a bottom face of the circular recessed part 6c.

Next, an operation of the clamp structure 1 will be described below.

In a waiting state where the tray 6 is not moved to a play position 15, the disk stopper 5 is moved to and located at a separated position from the hole 8a by the return spring 13 (FIG. 1). In this state, the up-and-down mechanism 9 does not lift the disk stopper 5.

When a disk 4 is to be played, the disk 4 is placed on the tray 6 to move it to the play position 15. The support part 5d of the disk stopper 5 is protruded at a higher position than a bottom plate of the tray 6 but, since the cut-out part 6a is formed in the tray 6, even when the tray 6 on which the disk 4 is placed begins to move toward the play position 15, the tray 6 is moved without abutting with the support part 5d for a while. In this state in the first embodiment, the support part 5d of the disk stopper 5 is located at a position lower than the disk 4 and thus the support part 5d passes under the disk 4.

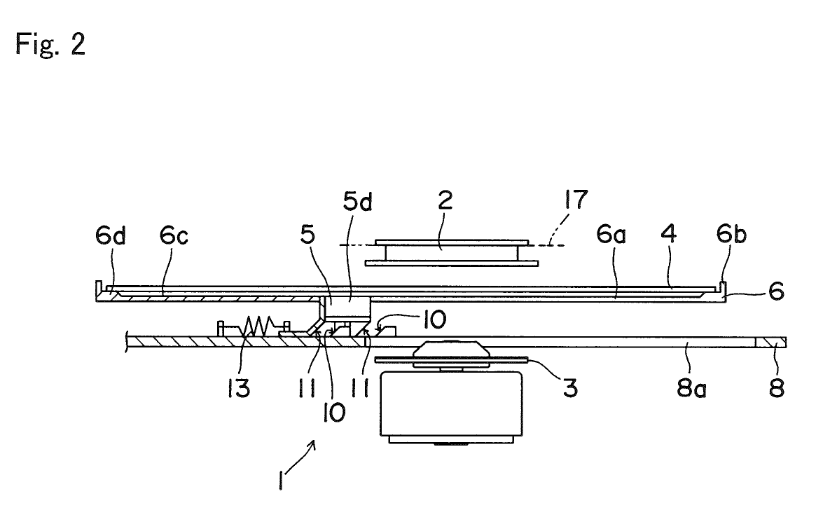

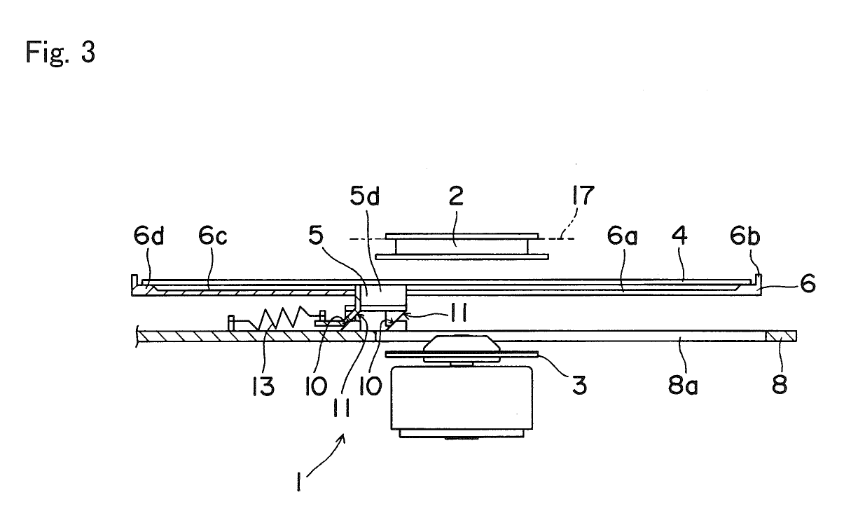

When the tray 6 is further moved, an edge of the cut-out-part 6a of the tray 6 is abutted with the support part 5d (FIG. 2 and FIG. 11(B)). Therefore, after that, the tray 6 is moved while causing the disk stopper 5 to slide against an urging force of the return spring 13. The disk stopper 5 which is slid is moved upward by the up-and-down mechanism 9 (FIG. 3). When the tray 6 is further moved, the support part 5d of the disk stopper 5 is further moved upward and abutted with the non-recording area 35 on an inner side with respect to the recording area 36 of the disk 4 to lift the disk 4 from the tray 6.

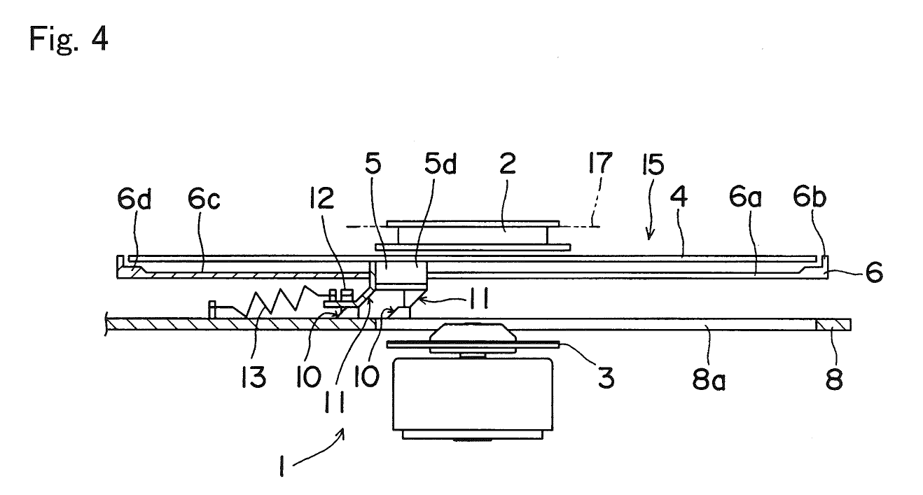

Immediately after that, the tray 6 has arrived at the play position 15 and stopped (FIG. 4). At the same time, the disk stopper 5 is also stopped. At this position, the up-and-down mechanism 9 has lifted the disk stopper 5 at the highest position.

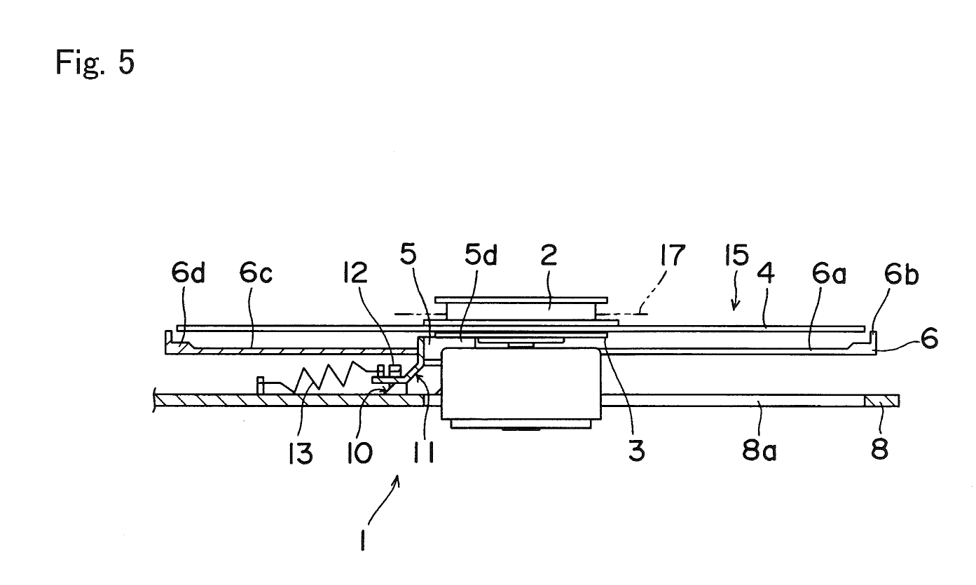

After that, the turntable 3 is moved upward from an under side of the chassis 8 and the turntable 3 is magnetically coupled to the clamper 2 while lifting the disk 4 (FIG. 5).

The turntable 3 is moved upward from the under side of the chassis 8 and, at the same time, the clamper holder 17 is moved downward and thus the clamper 2 is also moved downward a little. The turntable 3 is moved upward while lifting the disk 4 and magnetically coupled to the clamper 2. In this manner, the disk 4 is clamped by the turntable 3 and the clamper 2 in a state that the disk 4 is floated from the tray 6 and the support part 5d. In this state, the clamper 2 is also floated a little from the clamper holder 17. Further, the optical pickup is also moved upward together with the turntable 3 to face the disk 4. In this state, the disk 4 is played.

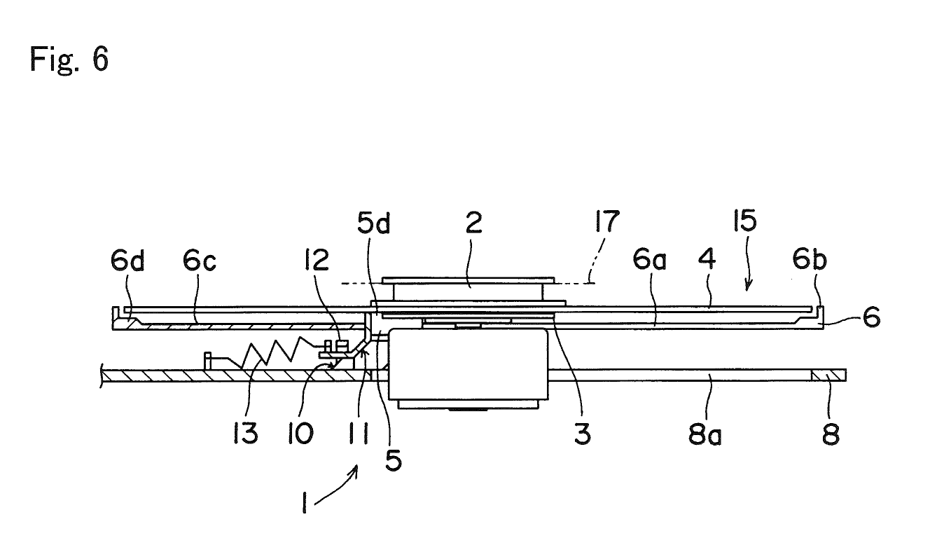

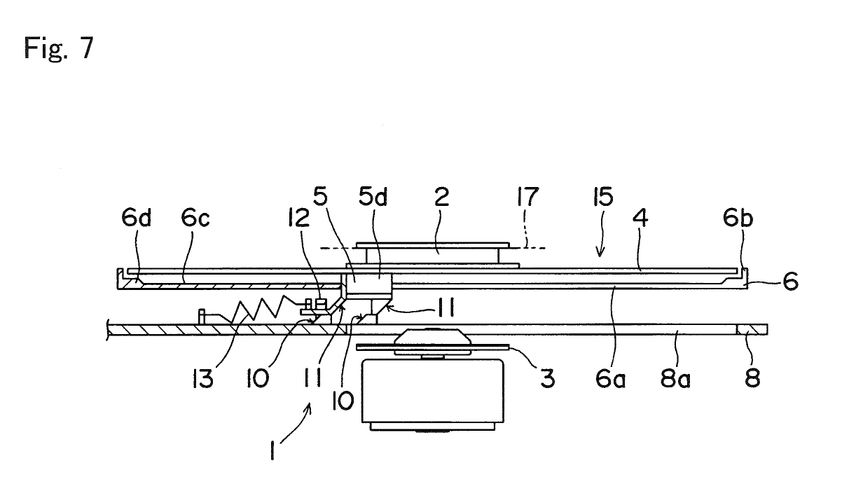

When the disk 4 is to be ejected after a play operation has ended, the turntable 3 and the optical pickup are moved downward (retreated). Since the turntable 3 is magnetically coupled to the clamper 2, the disk 4 and the clamper 2 are also moved downward together with the turntable 3 when the turntable 3 begins to move down. However, the disk 4 is immediately abutted with the support part 5d of the disk stopper 5 and thus the disk 4 is unable to move further downward (FIG. 6). In other words, the support part 5d of the disk stopper 5 supports the disk 4 and prevents the disk 4 and the clamper 2 from following to move together with the turntable 3 and thus the magnetic coupling of the turntable 3 to the clamper 2 is released (FIG. 7). Since the disk stopper 5 is supported by the chassis 8 having a sufficient strength, even when the turntable 3 is firmly magnetically coupled to the clamper 2, the reaction force from the disk 4 is firmly received by the chassis 8 and the magnetic coupling is released. In other words, even when strengths of part items such as the clamper holder 17, the frame 19 and the like are not enhanced so much, strength of the mechanism for releasing the magnetic coupling of the turntable 3 to the clamper 2 is enhanced. Therefore, the wall thickness of the clamper holder 17 and the frame 19 can be made thinner and their weights are reduced, or the clamper holder 17 and the frame 19 can be made smaller and lighter and thus their manufacturing cost can be reduced and the device can be made smaller. Further, since the magnetic coupling force between the turntable 3 and the clamper 2 can be strengthened, the device is easily capable of coping with a high speed of rotational speed of the disk 4.

When the magnetic coupling of the turntable 3 to the clamper 2 is released, the clamper holder 17 is moved upward to make the clamper 2 move upward.

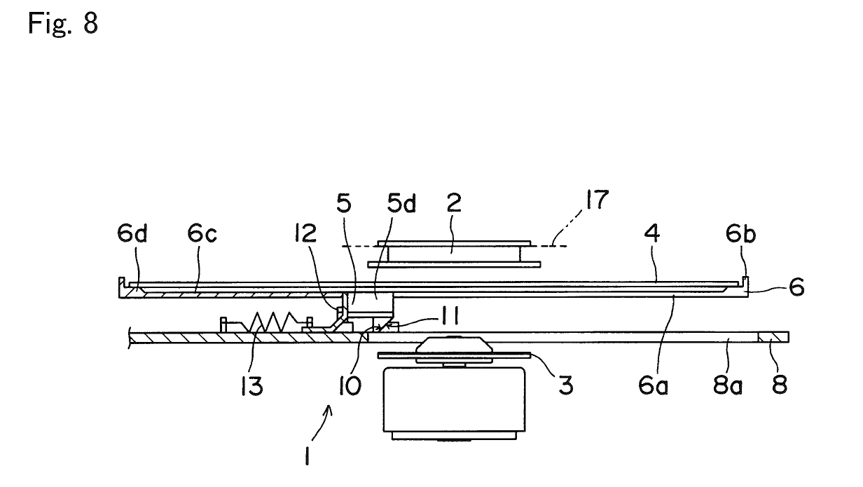

After that, when the turntable 3 and the optical pickup are retreated, the tray 6 begins to move in an eject direction. In this state, the disk 4 is lifted a little from the tray 6 by the support part 5d but the surrounding wall 6b of the circular recessed part 6c of the tray 6 pushes an outer peripheral face of the disk 4 and thus the disk 4 is also moved together with the tray 6. Further, when the tray 6 is moved, the disk stopper 5 is pulled by the return spring 13 and moved while sliding. The disk stopper 5 being slid is moved downward by the up-and-down mechanism 9 and thus the disk 4 lifted by the support part 5d is placed on the tray 6 (FIG. 8).

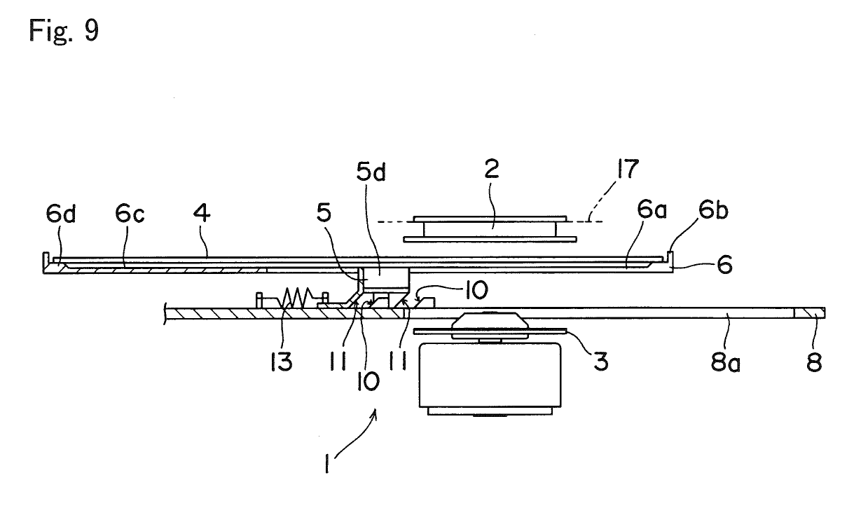

After that, the tray 6 and the disk stopper 5 are moved together for a while. However, when the disk stopper 5 is returned to the initial position 18, the rear side projecting part formed with the stopper side inclined face 11 is abutted with the front side projecting part formed with the chassis side inclined face 10 and the disk stopper 5 is stopped at the initial position 18. After that, the tray 6 is further moved (FIG. 9) to reach to the eject position not shown and stopped.

In the clamp structure 1, the reaction force from the disk 4 at the time of releasing the magnetic coupling is received and supported by the disk stopper 5. Therefore, the reaction force from the disk 4 is not required to be received by the clamp holder 17 and thus strengths can be lowered which are required for the clamp holder 17, the frame 19 for supporting the clamp holder 17, the mechanism for moving the clamp holder 17 up and down, and the like. Accordingly, the manufacturing cost of the clamp structure 1 can be reduced and the device can be made smaller and lighter.

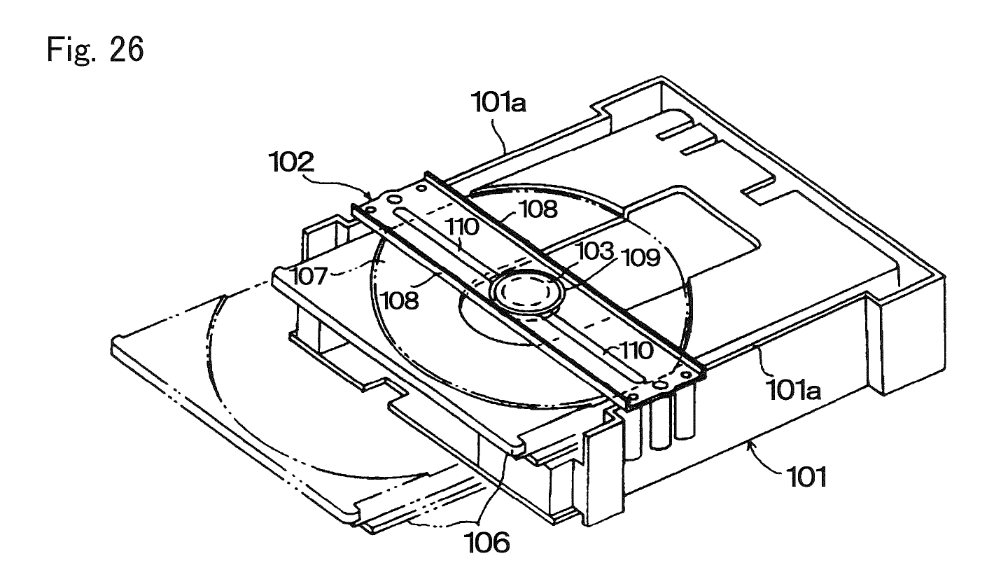

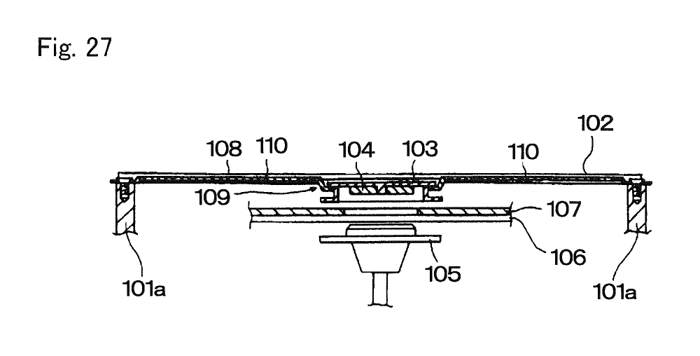

Further, in the conventional disk playing device shown in FIGS. 26 and 27, in a case that rigidity of the clamper plate 102 is insufficient, when the clamper 103 is to be separated from the turntable 105, resilient bending is occurred in the clamper plate 102 supporting the clamper 103 due to the magnetic coupling force of the clamper 103 to the turntable 105. In this state, when the clamper 103 is separated from the turntable 105, the resilient bending of the clamper plate 102 is recovered. At this time, the clamper 103 is bounded by returning motion of the resilient bending of the clamper plate 102 and thus vibration and noise may be occurred. However, according to the first embodiment of the present invention, since the disk stopper 5 is provided, a resiliently bending amount of the frame 19 is reduced and thus a moving amount and a moving force, which are applied to the clamper 2 due to the returning motion of the resilient bending, are reduced and bounding of the clamper 2 becomes smaller. As a result, occurrence of bounding and noise of the turntable 3, the clamper 2, the disk 4 and the like due to reaction against releasing of the magnetic coupling can be prevented.

Further, the support part 5d of the disk stopper 5 supports the non-recording area 35 except the recording area 36 of the under face of the disk 4 and thus a memory area of the disk 4 is prevented from being damaged.

Next, a clamp structure 1 in a disk playing device in accordance with a second embodiment of the present invention will be described below. The same notational symbols are used in the second embodiment for the same structural members as the clamp structure 1 of the first embodiment and their detailed descriptions are omitted, which is similar to a third embodiment and a fourth embodiment. In the first embodiment, the present invention is applied to a disk playing device in which a disk 4 is placed on and carried by the tray 6. However, in the second embodiment, the present invention is applied to a disk playing device in which a disk 4 is directly carried by a feeding roller 7 without using the tray 6.

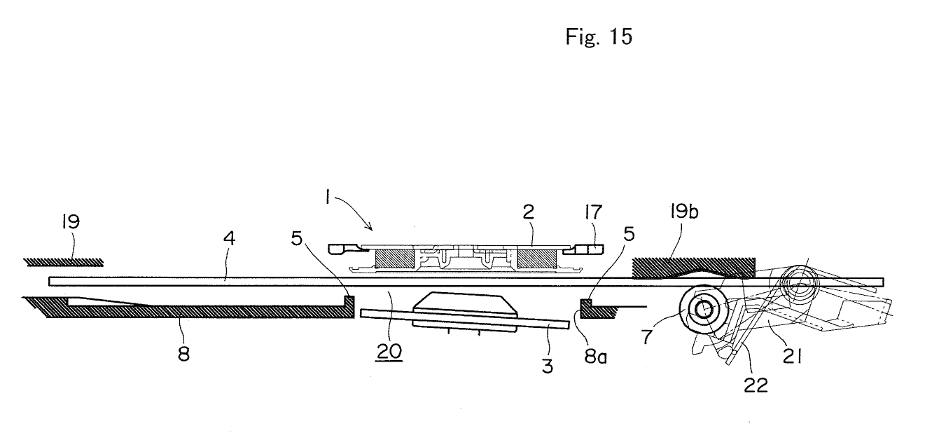

A disk playing device to which a clamp structure 1 in accordance with the second embodiment is applied is shown in FIGS. 15 through 17. A disk play operation space 20 is formed between a chassis 8 structuring a housing and a frame 19. The chassis 8 is formed with a hole 8a for passing the turntable 3 and a disk stopper 5 is formed by means of that at least a part of peripheral portion of the hole 8a which is a portion facing an inner non-recording area 35 (left side in FIG. 13) with respect to the recording area 36 of a disk 4 is protruded toward a frame 19 side. The disk stopper 5 is, similarly to the support part 5d in the first embodiment, capable of supporting the inner non-recording area of the disk 4 when magnetic coupling of the turntable 3 to the clamper 2 is to be released. In addition, the disk stopper 5 is overlapped with the clamper 2 in a radial direction and, in a state that a disk 4 is not loaded, when the turntable 3 and the clamper 2 are directly magnetically coupled to each other and the magnetic coupling is to be released, the clamper 2 is directly supported by the disk stopper 5. However, the disk stopper 5 is not always required to overlap with the clamper 2 in the radial direction. For example, when the turntable 3 and the clamper 2 are not directly magnetically coupled to each other or the like in a state that a disk 4 is not loaded, the disk stopper 5 may not be required to overlap with the clamper 2 in the radial direction, which is similar to the support part 5d in the first embodiment.

A feeding roller 7 for feeding a disk 4 into a disk play operation space 20 is rotatably supported by a swing arm 21 which is swingably attached to the chassis 8. The feeding roller 7 is always urged by a spring 22 toward a disk guide part 19b formed in the frame 19, i.e., in a direction abutting with the disk 4. In FIG. 15, when a disk 4 is inserted into a disk insertion port (not shown) which is formed on the right side, the feeding roller 7 begins to rotate and the disk 4 is carried toward the disk play operation space 20 while the disk 4 is sandwiched between the feeding roller 7 and the disk guide part 19b.

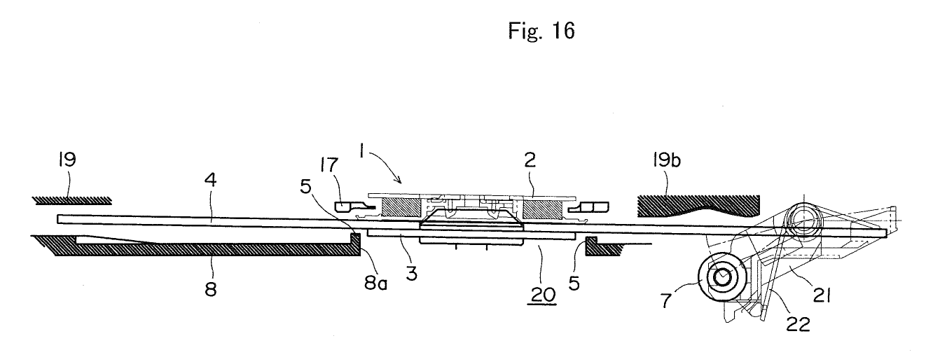

When the disk 4 has been carried into the disk play operation space 20, the feeding roller 7 is stopped. In this state, the disk 4 is sandwiched by the feeding roller 7 and the disk guide part 19b. Next, the turntable 3 is moved upward to pass the hole 8a formed in the chassis 8 and the clamper holder 17 is moved down. In this manner, the disk 4 is clamped by the turntable 3 and the clamper 2. A magnet is built into the clamper 2 and the turntable 3 and the clamper 2 are magnetically coupled to each other. After that, when the swing arm 21 is swung to make the feeding roller 7 retreat and the disk 4 is separated from the disk guide part 19b, the turntable 3 is rotated to start a play operation (FIG. 16).

The play operation has ended and, when the disk 4 is to be ejected, the feeding roller 7 is moved upward to sandwich the disk 4 with the disk guide part 19b. And, the turntable 3 is moved downward and the clamper 2 is moved upward.

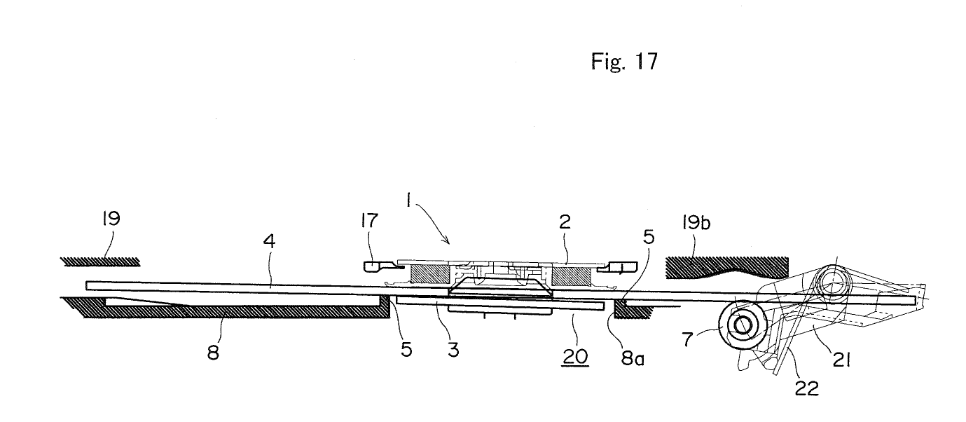

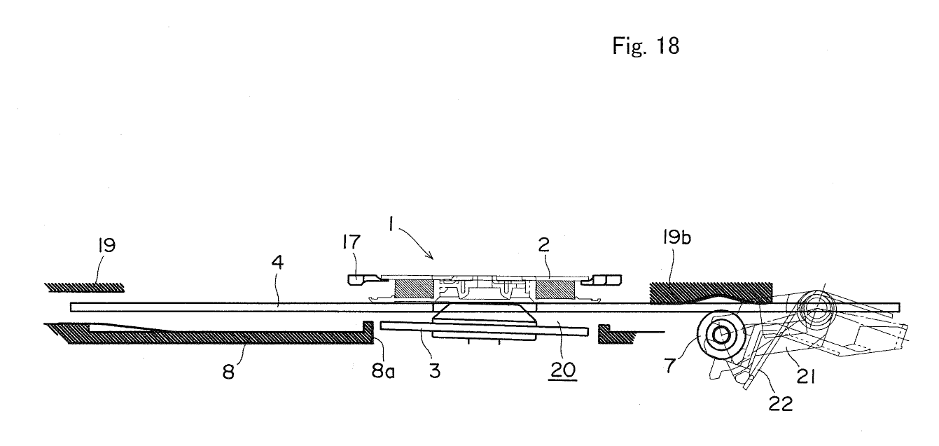

In a case that a magnetic coupling force of the clamper 2 is relatively weak, as shown in FIG. 18, the magnetic coupling of the turntable 3 to the clamper 2 is released only by means of that the turntable 3 is moved down and the clamper 2 is moved up. Therefore, even when the disk stopper 5 is not utilized, the magnetic coupling of the turntable 3 to the clamper 2 is released. However, in a case that a magnetic coupling force of the turntable 3 to the clamper 2 is strong, the magnetic coupling of the turntable 3 to the clamper 2 is not released only by means of that the turntable 3 is moved down and the clamper 2 is moved up. Therefore, the clamper 2 is attracted and pulled by the turntable 3 and moved down while the frame 19 supporting the clamper holder 17 is resiliently bent. In this case, the disk 4 sandwiched by the turntable 3 and the clamper 2 is also pulled by the turntable 3 and thus the disk 4 is moved down against the urging force of the spring 22 while depressing the feeding roller 7. Therefore, the disk 4 is abutted with the disk stopper 5 and, after that, the disk 4 is unable to be moved down (FIG. 17) and thus, when the turntable 3 is further moved down, the magnetic coupling of the turntable 3 to the clamper 2 is released and only the turntable 3 is moved down. When pulling by the turntable 3 is released, the clamper 2 is moved upward because resilient bending of the frame 19 is returned and the disk 4 is lifted by the feeding roller 7 to be sandwiched by the disk guide part 19b (FIG. 15). After that, the feeding roller 7 is rotated and the disk 4 is carried toward the disk insertion port.

The disk stopper 5 is formed in the chassis 8 having a sufficient strength and thus, even when the magnetic coupling of the turntable 3 to the clamper 2 is stronger, the disk stopper 5 is capable of receiving a large force (reaction force from the disk 4) required to release the magnetic coupling and the magnetic coupling is released. In other words, even when strengths of part items such as the frame 19 for supporting the clamper 2 are lowered, a strength as a mechanism for releasing the magnetic coupling of the turntable 3 to the clamper 2 can be enhanced. Therefore, the frame 19 and the like can be made thinner of its wall thickness and lighter of its weight, or can be made smaller and lighter and thus their manufacturing cost can be reduced. Further, since the magnetic coupling force between the turntable 3 and the clamper 2 can be further strengthened, the device is easily capable of coping with a high speed of rotational speed of the disk 4.

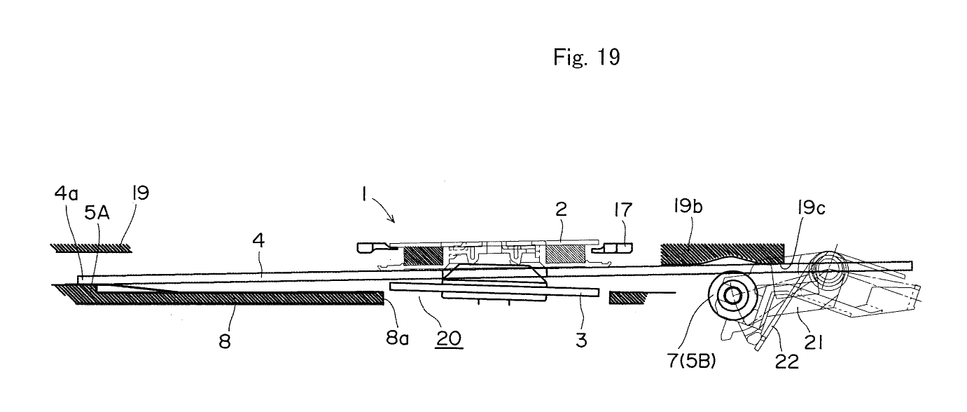

Next, a clamp structure 1 in a disk playing device in accordance with a third embodiment of the present invention will be described below. A clamp structure 1 in the third embodiment is shown in FIG. 19. In this embodiment, a disk stopper 5 (hereinafter, referred to as a first disk stopper 5A) is provided in the chassis 8 at a position facing a disk tip end portion 4a. Further, a feeding roller 7 is utilized as a disk stopper 5 (hereinafter, referred to as a second disk stopper 5B). In this embodiment, the tip end portion 4a of the disk 4 corresponds to the remotest position from the feeding roller 7 in an outer peripheral portion of the disk 4 (an outer non-recording area 35 except the recording area 36 of an under face of the disk 4) in FIG. 19. In other words, the tip end portion 4a of the disk 4 corresponds to a position opposite to the feeding roller 7 with respect to the turntable 3. In this embodiment, an additional separate member is not provided as the first disk stopper 5A and a portion of the chassis 8 abutting with the disk tip end portion 4a is utilized as the first disk stopper 5A as it is. However, it may be structured that a projecting part, for example, is separately provided in the chassis 8 at a position which is abutted with the disk tip end portion 4a to form the first disk stopper 5A. Further, in the second embodiment, the urging force of the spring 22 is set to be relatively weaker such that, when the disk 4 is moved down by being pulled by the turntable 3, the feeding roller 7 is depressed by the disk 4. However, in the third embodiment, the urging force of the spring 22 is set to be stronger so that, even when the disk 4 is going to be moved down by pulled by the turntable 3, the feeding roller 7 maintains the state where the disk 4 is sandwiched by the feeding roller 7 and the disk guide part 19b. The clamp structure 1 in this embodiment is suitable to be applied to a disk playing device in which a disk 4 that is relatively hard to resiliently bend is played.

In the disk playing device, when the disk 4 is to be ejected after play operation has ended, first, the feeding roller 7 is moved upward to sandwich the disk 4 by the feeding roller 7 and the disk guide part 19b and then the turntable 3 is moved down and the clamper holder 17 is moved upward. However, similarly to the second embodiment, since a magnetic coupling force between the turntable 3 and the clamper 2 is stronger, their magnetic coupling is not released and thus the clamper 2 is also pulled and moved down by the turntable 3 while the frame 19 is resiliently bent. However, in this embodiment, different from the second embodiment, the urging force of the spring 22 is set in strength so as to be capable of preventing the disk 4 from moving down and thus the feeding roller 7 is hardly depressed. Therefore, the disk 4 is moved down while inclining with a position 19c of the disk guide part 19b on an opposite side to the turntable 3 as a supporting point. As a result, the disk tip end portion 4a is abutted with the first disk stopper 5A and, after that, the disk 4 is unable to be moved down (FIG. 19). Therefore, when the turntable 3 is further moved down, the magnetic coupling of the turntable 3 to the clamper 2 is released and only the turntable 3 is moved down. In other words, the disk 4 and the clamper 2 are prevented from following and moving together with the turntable 3 by the first disk stopper 5A and the second disk stopper 5B, and magnetic coupling of the turntable 3 to the clamper 2 is released. Next, since the pulling by the turntable 3 is released and the clamper 2 is not pulled by the turntable 3, the bending of the frame 19 is returned to move the clamper 2 upward, and the disk 4 is sandwiched by the feeding roller 7 and the disk guide part 19b. After that, the feeding roller 7 is rotated to feed the disk 4 toward the disk insertion port.

Also in the third embodiment, similarly to the second embodiment, the first disk stopper 5A is formed in the chassis 8 itself having a sufficient strength and the second disk stopper 5B is the feeding roller 7 which is urged by the spring 22. Therefore, even when the magnetic coupling of the turntable 3 to the clamper 2 is stronger, large forces required to release the magnetic coupling are received by the chassis 8 and the feeding roller 7 to release the magnetic coupling. In other words, even when strengths of part items such as the frame 19 for supporting the clamper 2 are lowered, strength as a mechanism for releasing the magnetic coupling of the turntable 3 to the clamper 2 can be enhanced. Therefore, the thickness of the frame 19 and the like can be made thinner and its weight is reduced, or the frame 19 and the like can be made smaller and lighter and thus their manufacturing cost can be reduced. Further, since the magnetic coupling force between the turntable 3 and the clamper 2 can be further strengthened, the device is easily capable of coping with a high speed of rotational speed of the disk 4.

In the third embodiment, the disk stopper 5 which is formed so that at least a part of the peripheral portion of the hole 8a is protruded toward the frame 19 side may be used together.

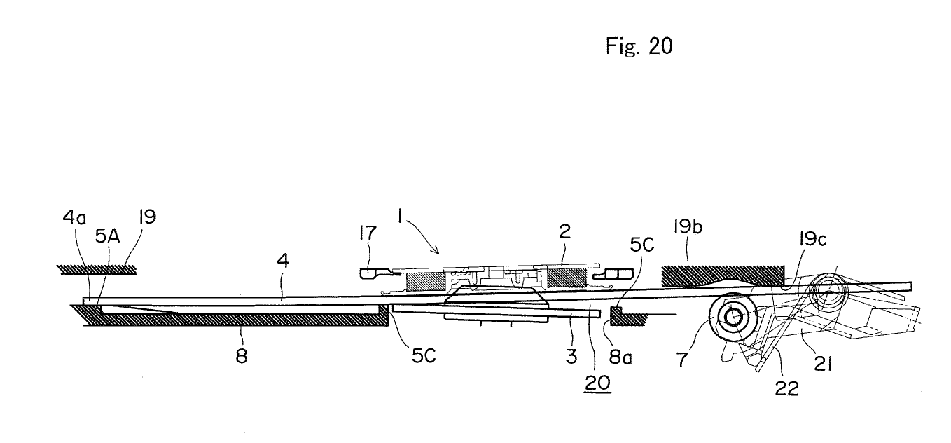

Next, a clamp structure 1 in a disk playing device in accordance with a fourth embodiment of the present invention will be described below. A clamp structure 1 in the fourth embodiment is shown in FIG. 20. The clamp structure 1 in the fourth embodiment is, in addition to the first disk stopper 5A and the second disk stopper 5B which are also provided in the clamp structure 1 in the third embodiment, provided with the disk stopper 5 which is provided in the clamp structure 1 in the second embodiment, i.e., the disk stopper 5 which is formed by means of that at least a part of the peripheral portion of the hole 8a of the chassis 8 is protruded (hereinafter, referred to as a third disk stopper 5C), which is different from the clamp structure 1 in the third embodiment. The clamp structure 1 in the fourth embodiment is suitable to be applied to a disk playing device in which a disk 4 that is relatively easy to resiliently bend is played.

In the disk playing device, when the disk 4 is to be ejected after a play operation has ended, first, the feeding roller 7 is moved upward to sandwich the disk 4 by the feeding roller 7 and the disk guide part 19b and then the turntable 3 is moved down and the clamper holder 17 is moved upward. Also in this embodiment, similarly to the second embodiment, since a magnetic coupling force of the turntable 3 to the clamper 2 is stronger, the magnetic coupling is not released and thus the clamper 2 is also pulled and moved down by the turntable 3 while the frame 19 is resiliently bent. In this case, different from the second embodiment, the urging force of the spring 22 is set to be stronger so that the feeding roller 7, i.e., the second disk stopper 5B is hardly depressed. Therefore, the disk 4 is moved down while inclining with a position 19c of the disk guide part 19b on an opposite side to the turntable 3 as a supporting point. As a result, the disk tip end portion 4a is abutted with the first disk stopper 5A. In this state, when the turntable 3 is further moved down, the disk 4 is resiliently bent and a center portion of the disk 4 is abutted with the third disk stopper 5C and, after that, the disk 4 is unable to be moved down (FIG. 20). Therefore, when the turntable 3 is further moved down, the magnetic coupling of the turntable 3 to the clamper 2 is released and only the turntable 3 is moved down. Further, since the pulling by the turntable 3 is released and the clamper 2 is not pulled by the turntable 3, the bending of the frame 19 is returned to move the clamper 2 upward, and the disk 4 is sandwiched by the feeding roller 7 and the disk guide part 19b. After that, the feeding roller 7 is rotated to feed the disk 4 toward the disk insertion port.

Also in the fourth embodiment, the first disk stopper 5A and the third disk stopper 5C are formed in the chassis 8 having a sufficient strength and thus, even when the magnetic coupling of the turntable 3 to the clamper 2 is stronger, large forces required to release the magnetic coupling are received by the first disk stopper 5A and the third disk stopper 5C to release the magnetic coupling. In other words, even when strengths of part items such as the frame 19 for supporting the clamper 2 are lowered, strength as a mechanism for releasing the magnetic coupling of the turntable 3 to the clamper 2 can be enhanced. Therefore, the thickness of the frame 19 and the like can be made thinner and its weight is reduced, or the frame 19 and the like can be made smaller and lighter and thus their manufacturing cost can be reduced. Further, since the magnetic coupling force between the turntable 3 and the clamper 2 can be further strengthened, the device is easily capable of coping with a high speed of rotational speed of the disk 4.

In the fourth embodiment, the feeding roller 7 may not be used as the disk stopper 5 which is different from the third embodiment.

Although the present invention has been shown and described with reference to the specific embodiments, various changes and modifications will be apparent to those skilled in the art from the teachings herein.

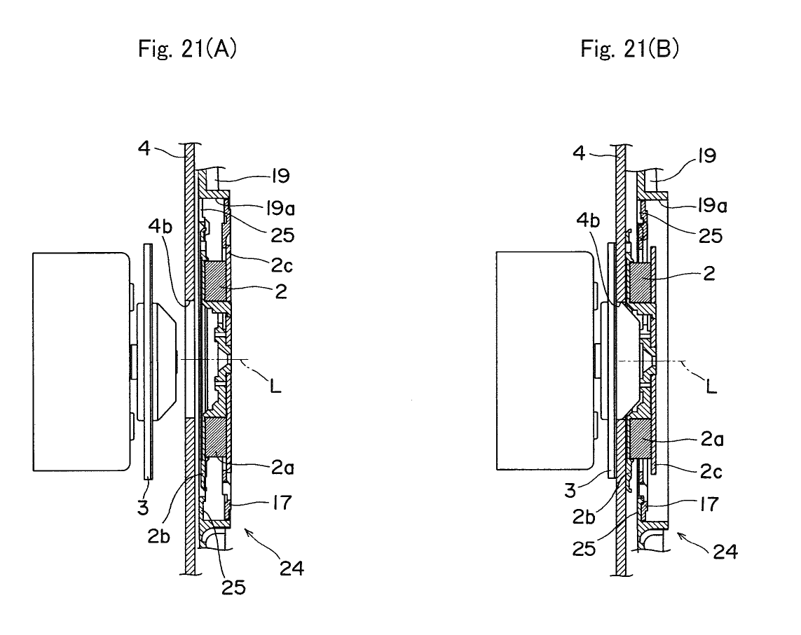

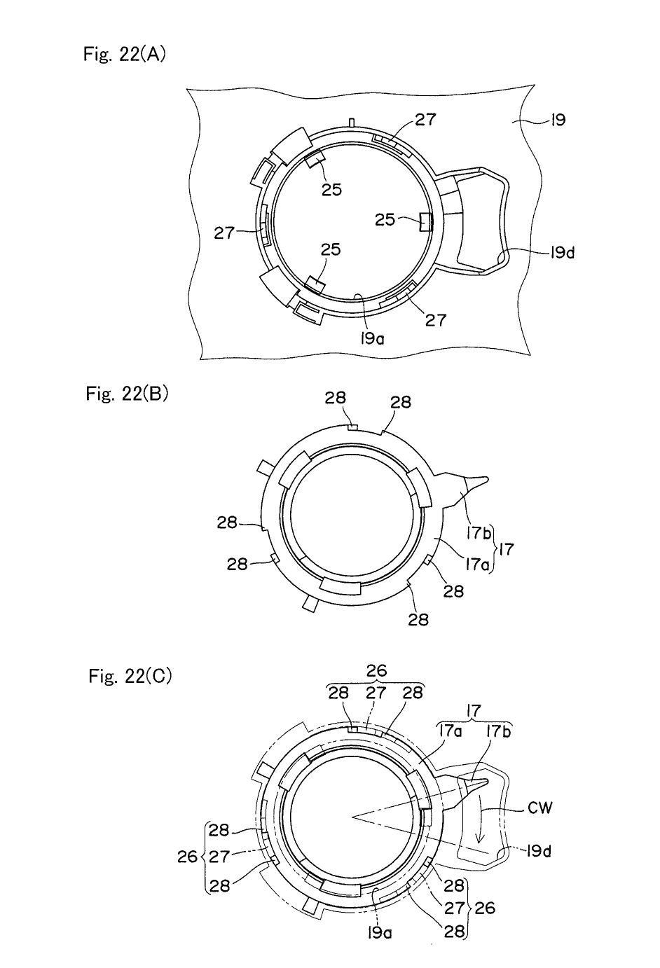

Next, a support structure 24 for the clamper 2 will be described below. The support structure 24 for the clamper 2 is shown in FIG. 21(A) through FIG. 23(C). FIG. 22(A) is a plan view showing the hole 19a of the frame 19, FIG. 22(B) is a plan view showing the clamper holder 17, and FIG. 22(C) is a plan view showing a positional relationship of the clamper holder 17 and the hole 19a. The support structure 24 for the clamper 2 is especially suitable to be applied to a vertical type disk playing device (disk standing type). In this embodiment, a vertical type disk playing device will be described. However, this embodiment may be applied to a horizontal type disk playing device or the like (for example, a type in which a disk 4 is handled in a laid horizontal state like the first embodiment).

The clamper 2 is disposed on an opposite side to the turntable 3 across a feeding passage for the disk 4. The clamper 2 is held by the clamper holder 17 and the clamper 2 is mounted on the frame 19 of the disk playing device movably in a perpendicular direction (horizontal direction because this embodiment is a vertical type disk playing device). The hole 19a for disposing the clamper 2 is formed in the frame 19. Protruding pieces 25 are provided on an edge on a turntable 3 side of the hole 19a. The protruding piece 25 is formed, for example, at three positions with an equal interval in a circumferential direction. However, the number of the protruding pieces 25 is not limited to three.

The clamper holder 17 in this embodiment is structured of a ring part 17a for holding the clamper 2 and an arm part 17b which is integrally formed with the ring part 17a. The ring part 17a is provided so as to surround an intermediate part 2a of the clamper 2 with a gap space as a play between the ring part 17a and the intermediate part 2a. An inner diameter of the ring part 17a is larger than an outer diameter of the intermediate part 2a of the clamper 2 and smaller than outer diameters of the clamp part 2b and a back part 2c. Therefore, the clamper holder 17 is relatively movable between the clamp part 2b and the back part 2c in a direction getting closer to and separating from a disk 4. Further, an outer diameter of the ring part 17a is set to be slightly smaller than the diameter of the hole 19a (FIGS. 21(A) and 21(B)). Therefore, the clamper holder 17 is movable in an axial line “L” direction and is turnable around the axial line “L” within the hole 19a. The arm part 17b is extended to an outer side of the ring part 17a in a radial direction and is operated by an operation lever not shown through a window 19d formed in the frame 19.

A guide mechanism 26 for guiding the clamper holder 17 is provided between the frame 19 and the clamper holder 17. The guide mechanism 26 is structured of an inclined plate 27 and a slider 28. In this embodiment, the guide mechanism 26 is provided, for example, at three positions with an equal interval in a circumferential direction of the hole 19a of the frame 19 and the ring part 17a, and the guide mechanism 26 functions like, so to say, a three-threaded screw to turnably move the clamper holder 17 in the axial direction. However, the number of the positions where the guide mechanisms 26 is provided is not limited to three. The inclined plate 27 is provided so as to structure a part of spiral on a peripheral face of the hole 19a of the frame 19. Both front and rear faces 27a and 27b of the inclined plate 27 are respectively formed to be guiding faces. The slider 28 is structured of a front side slider 28 which slides on a front face 27a of the inclined plate 27 and a rear side slider 28 which slides on a rear face 27b of the inclined plate 27. The slider 28 is provided in the ring part 17a of the clamper holder 17. Both front and rear faces (both guide faces) 27a and 27b are formed with recessed parts 27c and 27d to which the respective sliders 28 are fitted.

Next, an operation of the support structure 24 of the clamper 2 will be described below.

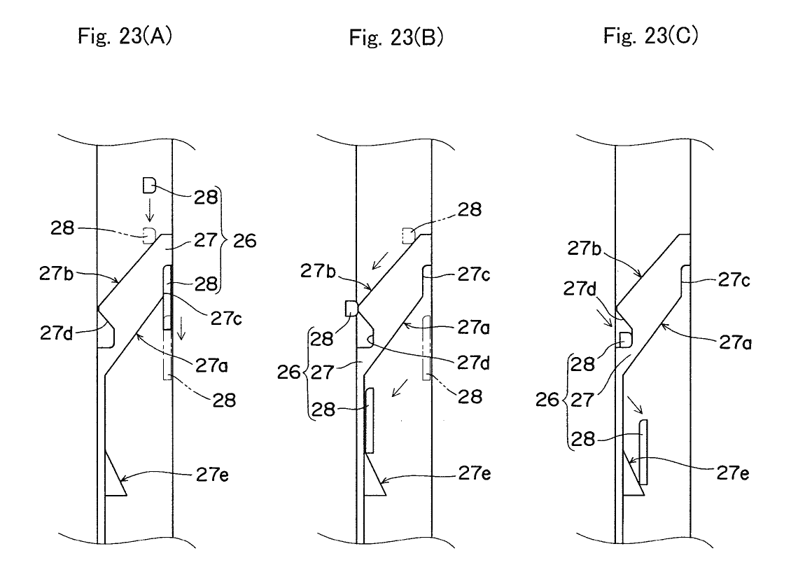

In the states as shown by the solid line in FIG. 22(C) and FIG. 23(A), the clamper holder 17 is located at a position having moved to the most separated position from the feeding passage for a disk 4 (FIG. 21(A)). In this state, the operation lever is operated by a drive source such as an electric motor not shown and the arm part 17b is moved to turn the ring part 17a in a direction shown by the arrow “CW” in FIG. 22(C). As a result, the sliders 28 of the guide mechanism 26 are moved in a direction shown by the arrows in FIG. 23(A). After that, when the sliders 28 of the guide mechanism 26 is further moved in the same direction, the rear side slider 28 is abutted with the guide face 27b as shown by the two-dot chain line in FIGS. 23(A) and 23(B) and, after that the rear side slider 28 is guided and moved by the guide face 27b. In this manner, the clamper holder 17 is moved toward the feeding passage 23 side while the clamper holder 17 is turned such that a screw is turned and advanced. In this case, the front side slider 28 and the rear side slider 28 are moved together without varying their positional relationship. When the sliders 28 are reached to the position as shown by the solid line in FIG. 23(B), the clamper holder 17 becomes in a state nearest to the feeding passage 23 (FIG. 21(B)).

In the state as shown by the solid line in FIG. 23(B), when the clamper holder 17 is further turned by the operation lever, the front side slider 28 is moved along an extension slant face 27e formed in the inclined plate 27 so that the clamper holder 17 is moved back a little in a direction away from the feeding passage. Further, the rear side slider 28 is fitted into a recessed part 27d of the guide face 27b (FIG. 23(C)). At the same time, since the turning operation of the arm part 17b by the operation lever is stopped, turning of the ring part 17a is also stopped. In this state, the rear side slider 28 is fitted into the recessed part 27d and thus rattling of the clamper holder 17 is prevented.

In this state, when the operation lever moves the arm part 17b to turn the ring part 17a in the opposite direction, the rear side slider 28 is moved along the inclined face of the recessed part 27d and makes the clamper holder 17 move a little toward the feeding passage side to return to the state as shown by the solid line in FIG. 23(B). After that, when the ring part 17a is further turned, the front side slider 28 is abutted with the guide face 27a and then the front side slider 28 is guided and moved by the guide face 27a. In this manner, the clamper holder 17 is moved in a direction away from the feeding passage 23 while being turned such that a screw is turned and retreated.

After that, as shown in FIG. 23(A), when the front side slider 28 is fitted to the recessed part 27c of the guide face 27a, the operation of the arm part 17b by the operation lever is stopped and turning of the ring part 17a is stopped. In this state, the clamper holder 17 has been moved to the remotest position from the feeding passage. Further, in this state, since the front side slider 28 is fitted to the recessed part 27c, rattling of the clamper holder 17 is prevented.

When a disk 4 is to be carried, the state shown in FIG. 23(A) is set so that the clamper holder 17 and the clamper 2 are located at the remotest position from the feeding passage. Further, when the disk 4 is clamped, in other words, when the disk 4 is sandwiched by the turntable 3 and the clamper 2, the state shown in FIG. 23(B) is set so that the clamp holder 17 and the clamper 2 are moved to the position nearest to the feeding passage. In addition, when the disk 4 is played (at the time of play operation), the state shown in FIG. 23(C) is set so that the clamper holder 17 is kept away a little from the turntable 3 and so that the clamper holder 17 is not interfered with the clamper 2 even when the clamper 2 is pushed back for magnetic coupling to the turntable 3.

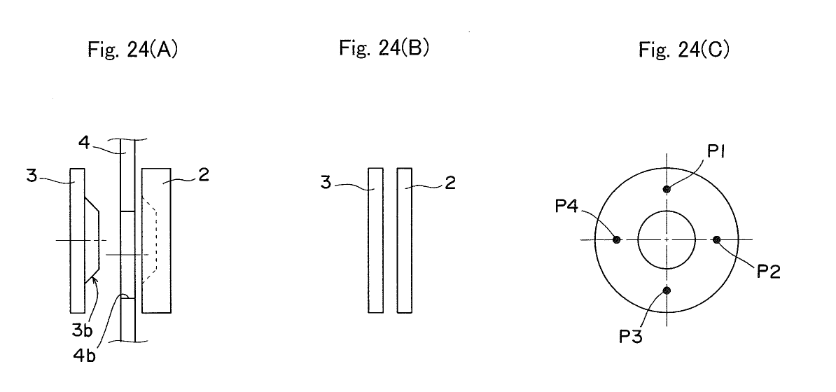

The clamper holder 17 is moved while being guided by a plurality of, in this embodiment, three guide mechanisms 26 and thus the clamper holder 17 is moved without being inclined such that a screw is turned and advanced while its attitude perpendicular to an axial direction of the hole 19a is maintained. Therefore, as shown in FIGS. 24(A), 24(B) and 24(C), inclination of the clamper 2 to the turntable 3 and the disk 4 is restrained.

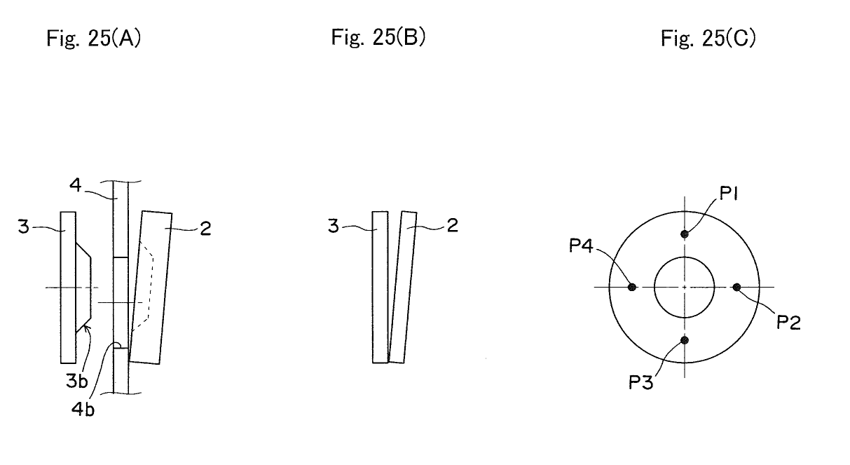

In other words, in a vertical type disk playing device, as shown in FIGS. 25(A), 25(B) and 25(C), the clamper 2 which is rotatably held is easily inclined. In a clamp structure of a type where a disk 4 is clamped by magnetic coupling of the clamper 2 to the turntable 3, when the clamper 2 is inclined with respect to the turntable 3, a magnetic coupling force acting between the turntable 3 and the clamper 2 is decreased by its amount of the inclination. This will be described below with reference to FIGS. 24(A), 24(B) and 24(C) and FIGS. 25(A), 25(B) and 25(C).

A distance between the clamper 2 and the turntable 3 is set to be 1 (one) when the clamper 2 is not inclined to the turntable 3. In a case that four points “P1” through “P4” shown in FIG. 24(C) are adopted as representative points (distances of respective points: 1), the magnetic coupling force is expressed as the following expression 1.

$$\begin{matrix}Magnetic coupling force = ( {1}^{⋒} 2 ) / ( {1}^{⋒} 2 ) \times 4 \\ = 4\end{matrix} \qquad < Expression 1 >$$

On the other hand, when the clamper 2 is inclined with respect to the turntable 3 and distances of four points shown in FIG. 25(C) are respectively “P1”=2, “P2”=“P4”=1, and “P3”=0, the magnetic coupling force is expressed as the following expression 2.

$$\begin{matrix}Magnetic coupling force = ( 1 / ( {2}^{⋒} 2 ) ) + \\ ( 1 / ( {1}^{⋒} 2 ) ) + \\ ( 1 / ( {1}^{⋒} 2 ) ) + 0 \\ = 0.25 + 1 + 1 + 0 \\ = 2.25\end{matrix} \qquad < Expression 2 >$$

Therefore, the magnetic coupling force when inclined is about 56% with respect to the magnetic coupling force when not inclined as shown by the expression 3.

2.25÷4=0.5625≈0.56 (Expression 3)

As described above, when the clamper 2 is inclined with respect to the turntable 3, the magnetic coupling force is decreased and thus the clamper 2 is required so as not to incline with respect to the turntable 3. In the support structure 24 for the clamper 2, the clamper holder 17 holding the clamper 2 is moved in parallel state without being inclined with respect to the turntable 3 and, since the clamper 2 is hardly inclined with respect to the clamper holder 17, inclination of the clamper 2 is restrained. Therefore, magnetic force of a magnet in the clamper 2 is effectively utilized as the magnetic coupling force and thus a size of the magnet can be reduced. Further, since the magnet can be made smaller, a large noise can be prevented from being occurred at the time of magnetic coupling of the turntable 3 to the clamper 2 (at the time of chucking) and at the time of the coupling release (chucking release).

Further, only the clamper holder 17 is added in comparison with a structure in which the clamper is directly attached to the frame and the number of part items is not increased so much and thus manufacturing cost is prevented from increasing largely. Further, since a spring and the like are not used, workability at the time of manufacturing is not impaired.

In a common clamp structure where a disk 4 is sandwiched by the turntable 3 and the clamper 2, when the rotation center axis of the turntable 3 and the rotation center axis of the disk 4 are displaced (FIG. 24(A) and FIG. 25(A)), an edge of a center hole 4b of the disk 4 (FIG. 24(A) and FIG. 25(A)) is slid along an inclined face 3b of the turntable 3 to coincide their rotation center axes with each other (centering). In the support structure 24 for the clamper 2 in this embodiment, inclination of the clamper 2 is restrained and a magnetic force is utilized as a magnetic coupling force required for clamping and thus the support structure 24 is preferable for centering. Especially, in a vertical type disk playing device, a direction in which a disk 4 is placed on the turntable 3 is different from a direction of gravity and thus the weight of the disk 4 cannot be utilized for centering of the disk 4. Further, in a vertical type disk playing device, the rotation center axis of the turntable 3 and the rotation center axis of the disk 4 are easily displaced from each other in comparison with a horizontal disk playing device (FIG. 24(A) and FIG. 25(A)). The support structure 24 for the clamper 2 utilizes the magnetic force of the magnet as the magnetic coupling force and thus the support structure 24 is suitable especially for a vertical type disk playing device.

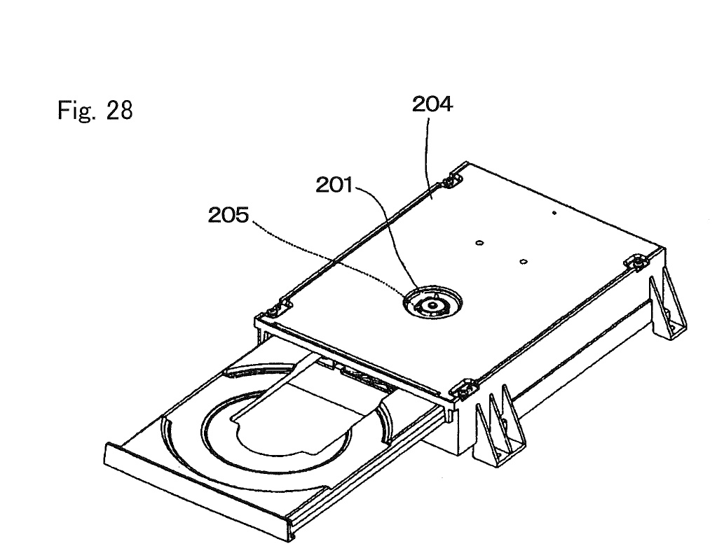

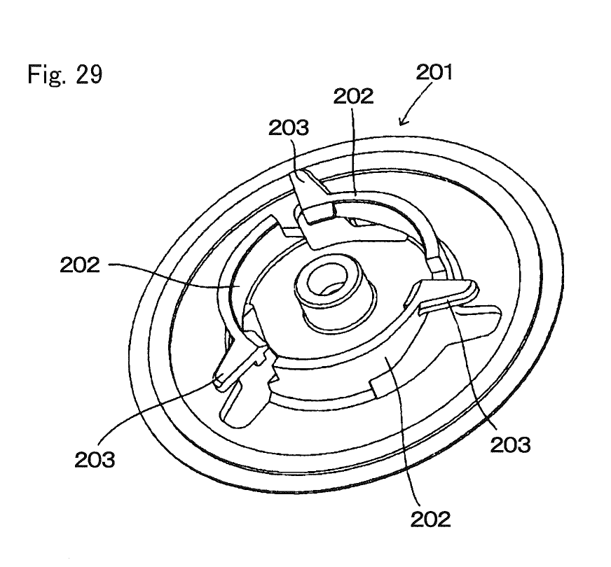

For example, in a disk playing device disclosed in Japanese Patent Laid-Open No. 2007-66429, as shown in FIG. 28 and FIG. 29, engagement fins 203 are provided in spring-shaped arm pieces 202 which are provided in the clamper 201 and, after the engagement fins 203 are passed through an opening part 205 of a plate 204, the engagement fins 203 are widened to attach the clamper 201 to the plate 204. Therefore, especially in a vertical type disk playing device, the clamper 201 is easily inclined with respect to the plate 204 and the clamper 201 is easily inclined with respect to the turntable. On the other hand, in the support structure 24 for the clamper 2, as described above, the clamper 2 can be clamped in a parallel state without being inclined with respect to the turntable 3.

In the embodiment described above, when a disk 4 is played, as shown in FIG. 23(C), the clamp holder 17 is kept away a little from the turntable 3 but the structure is not limited to this embodiment. For example, a disk 4 may be played in a state where the clamp holder 17 is located at the nearest position to the turntable 3. In other words, the clamper holder 17 may be moved between the state in FIG. 23(A) and the state in FIG. 23(B) without the state in FIG. 23(C).

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A clamp structure in a disk playing device in which a clamper and a turntable are magnetically coupled to each other to sandwich a disk therebetween, and in which one member of the clamper and the turntable is separated from the other member of the clamper and the turntable to release magnetic coupling and detach the disk, the clamp structure comprising:
a disk stopper for supporting the disk when the one member is to be separated from the other member to prevent the disk and the other member from following and moving together with the one member.

2. The clamp structure in a disk playing device according to claim 1, wherein the disk stopper is disposed so as to face a non-recording area except a recording area of the disk and the disk stopper is supported by a chassis.

3. The clamp structure in a disk playing device according to claim 2, wherein
the disk stopper is provided on the chassis so as to be capable of sliding in a feeding direction of the disk, and
an up-and-down mechanism for moving the disk stopper up and down by sliding of the disk stopper is provided between the disk stopper and the chassis.

4. The clamp structure in a disk playing device according to claim 1, wherein the disk stopper is a part of a chassis which faces a non-recording area except a recording area of the disk.

5. The clamp structure in a disk playing device according to claim 4, wherein
the chassis is formed with a hole for passing the turntable, and
at least a part of a peripheral portion of the hole which faces a non-recording area on an inner side with respect to a recording area of the disk is protruded toward a clamper side to form a third disk stopper as the disk stopper.

6. The clamp structure in a disk playing device according to claim 4, wherein
the chassis is formed with a first disk stopper as the disk stopper at a position facing a tip end portion of the disk, and
the position of the first disk stopper is a position facing an outer circumferential edge portion of the disk carried in a disk play operation space, and the position of the first disk stopper is the position on an opposite side to a feeding roller for feeding the disk into the disk play operation space with respect to the turntable.

7. The clamp structure in a disk playing device according to claim 1, wherein the disk stopper is a feeding roller for feeding the disk into a disk play operation space.

8. The clamp structure in a disk playing device according to claim 7, wherein
the feeding roller is attached to the chassis so that the feeding roller is urged for abutting with the disk by a spring, and
an urging force of the spring which is applied to the feeding roller is set so that the feeding roller abutting with the disk is prevented from following the turntable when the turntable is to be separated from the clamper.

9. The clamp structure in a disk playing device according to claim 8, wherein
the feeding roller is rotatably supported by a swing arm which is swingably attached to the chassis, and
when the disk is to be ejected, the feeding roller is moved and abutted with the disk through the swing arm and the turntable is separated from the clamper through the feeding roller and the disk.

10. The clamp structure in a disk playing device according to claim 7, wherein
the chassis is formed with a first disk stopper as another disk stopper at a position facing a tip end portion of the disk, and
the position of the first disk stopper is a position facing an outer circumferential edge portion of the disk carried in a disk play operation space, and the position of the first disk stopper is the position on an opposite side to a feeding roller for feeding the disk into the disk play operation space with respect to the turntable.

11. The clamp structure in a disk playing device according to claim 7, wherein
the chassis is formed with a hole for passing the turntable, and
at least a part of a peripheral portion of the hole which faces a non-recording area on an inner side with respect to a recording area of the disk is protruded toward a clamper side to form a third disk stopper as another disk stopper.
